(19) United States
(12) Patent Application Publication
(10) Pub. No.: US 2011/0245937 A1
(43) Pub. Date: Oct. 6, 2011

(54) SYSTEM AND METHOD FOR INTEROPERABILITY BETWEEN CARBON CAPTURE SYSTEM, CARBON EMISSION SYSTEM, CARBON TRANSPORT SYSTEM, AND CARBON USAGE SYSTEM

(75) Inventors: James Rulon Young Rawson, Clifton Park, NY (US); Richard Anthony DePuy, Burnt Hills, NY (US); Norman Zethward Shilling, Schenectady, NY (US); Emily Norman, Houston, TX (US); Pradeep S. Stanley Thacker, Houston, TX (US); Brian Charles Blakey, Houston, TX (US)

(73) Assignee: General Electric Company, Schenectady, NY (US)

(21) Appl. No.: 12/752,051

(22) Filed: Mar. 31, 2010

(51) Int. Cl. G05B 13/04; G06G 7/48; G06F 17/50

(52) U.S. Cl. 700/90; 703/6; 703/1

(57) ABSTRACT

Systems and methods are disclosed herein for enhancing interoperability of a plant. Such systems and methods include a carbon emission, capture, transport, and usage model. The carbon emission, capture, transport, and usage model is capable of modeling interrelationships of inputs, outputs, and requirements between a carbon emitting plant, the carbon capture process, a carbon transportation system, and a carbon usage system. The carbon emitting plant is capable of producing a product having a carbonaceous substance. The carbon capture process is capable of capturing at least a portion of the carbonaceous substance from the product as a carbonaceous gas. The carbon transportation system is capable of transporting the carbonaceous gas from the carbon capture process to the carbon usage system. The carbon usage system is capable of receiving the carbonaceous gas transported by the carbon transportation system.

### BACKGROUND OF THE INVENTION

The subject matter disclosed herein relates to systems and methods relating to carbon capture.

A variety of systems may produce and/or use a carbonaceous gas, such as carbon dioxide (CO₂). For example, an upstream system may produce CO₂, a carbon capture system may capture the CO₂, and a downstream system may receive or use the CO₂. One example of the upstream system is a gasification system. Unfortunately, the upstream system, the carbon capture system, and the downstream system are generally independent from one another. For example, the downstream system may be separate and remote from the upstream system and the carbon capture system. The upstream system may not be designed with consideration of various operating parameters of the carbon capture system and/or the downstream system. Likewise, the carbon capture system may be designed without consideration of various operating parameters of the upstream system and/or the downstream system, and the downstream system may be designed without consideration of various operating parameters of the upstream system and/or the carbon capture system. In other words, each system is designed without any consideration of interoperability with the other systems.

### BRIEF DESCRIPTION OF THE INVENTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In a first embodiment, a system for enhancing interoperability of a plant includes a carbon emission, capture, transport, and usage model. The carbon emission, capture, transport, and usage model is capable of modeling interrelationships of inputs, outputs, and requirements between a carbon emitting plant, the carbon capture process, a carbon transportation system, and a carbon usage system. The carbon emitting plant is capable of producing a product having a carbonaceous substance. The carbon capture process is capable of capturing at least a portion of the carbonaceous substance from the product as a carbonaceous gas. The carbon transportation system is capable of transporting the carbonaceous gas from the carbon capture process to the carbon usage system. The carbon usage system is capable of receiving the carbonaceous gas transported by the carbon transportation system.

In a second embodiment, a system includes a gasification section capable of converting a feedstock into a syngas and a carbon capture section capable of removing a carbonaceous gas from the syngas. The system also includes a controller capable of controlling the operation of the gasification section and the carbon capture section based on a carbon emission, capture, transport and usage model. The carbon emission, capture, transport and usage model is able to model interrelationships between inputs, outputs, and requirements of the gasification section, the carbon capture section, a pipeline system, and a carbon usage system.

In a third embodiment, a method includes modeling interrelationships of inputs, outputs, and requirements between a gasification system, a carbon capture process, a pipeline system, and a carbon usage system. The gasification system is capable of producing a syngas having a carbonaceous substance. The carbon capture process is capable of capturing at least a portion of the carbonaceous substance from the syngas as carbon dioxide (CO₂). The pipeline system is capable of transporting the CO₂ from the carbon capture process to the carbon usage system. The carbon usage system is capable of receiving the CO₂ from the pipeline system.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 depicts a block diagram of an embodiment of a carbon capture process (CCP) capable of interoperations with embodiments of a power plant, a chemical production plant, a chemical refinery plant, a carbon sequestration system, an enhanced oil recovery (EOR) system, and a pipeline system;

FIG. 2 depicts a block diagram of an embodiment of an integrated gasification combined cycle (IGCC) power plant capable of interoperations with embodiments of the CCS, the carbon sequestration system, the EOR system, and the pipeline system depicted in FIG. 1;

FIG. 3A depicts an upstream section of an embodiment of a carbon emission, capture, transport, and usage model;

FIG. 3B depicts a downstream section of the embodiment of a carbon emission, capture, transport, and usage model depicted in FIG. 3A;

FIG. 4 illustrates a first embodiment of a plurality of interrelationship data capable of being used by the model depicted in FIGS. 3A-3B;

FIG. 5 illustrates second embodiment of a plurality of interrelationship data capable of being used by the model depicted in FIGS. 3A-3B;

FIG. 6 illustrates a third embodiment of a plurality of interrelationship data capable of being used by the model depicted in FIGS. 3A-3B;

FIG. 7 illustrates a fourth embodiment of a plurality of interrelationship data capable of being used by the model depicted in FIGS. 3A-3B;

FIG. 8 depicts an embodiment of a logic that may be used to design a plant; and

FIG. 9 depicts another embodiment of a logic that may be used to design a plant.

### DETAILED DESCRIPTION OF THE INVENTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

The disclosed embodiments include systems and methods for operating, designing, optimizing, and/or simulating a carbon emitting plant (e.g., power plant, chemical production plant, chemical refinery plant), a carbon capture process, a carbon transportation system (e.g., pipeline system), and a carbon usage system (e.g., carbon sequestration system, enhanced oil recovery system), based on the interrelationships between the carbon emitting plant, the carbon capture process, the carbon transportation system, and the carbon usage system. For example, the interrelationships may include various inputs and outputs of each system or process. By capturing and utilizing the interrelationships between the aforementioned systems, it may be possible to optimize and/or efficiently design, build, retrofit and operate the carbon emitting plant, carbon capture process, carbon transportation system, and carbon usage system. Indeed, by utilizing the techniques disclosed herein, it may be possible to substantially lower the capital expenditures and operational expenditures of the aforementioned systems while reducing or eliminating the emission of greenhouse gases into the atmosphere. For example, the disclosed embodiments may substantially match the inputs and outputs of the various systems and processes with one another, thereby reducing waste and improving overall efficiency and performance across the systems and processes. In another example, the disclosed embodiments may allow for the design of systems that include desired interoperability requirements, thus improving the interaction between the systems. In yet another example, the disclosed embodiments may aid in the regulatory permitting of systems. In this example, the disclosed embodiments may provide for a performance data basis suitable for state and federal regulatory permitting, including National Emission Standards for Hazardous Air Pollutants (NESHAPs), and Maximum Achievable Control Technology (MACT).

As discussed in further detail below, the disclosed embodiments include the creation of a model, such as a carbon emission, capture, transport, and usage model. The model is capable of capturing the interrelationships (e.g., inputs, outputs, and requirements) between a plurality of systems such as the carbon emitting plant, the carbon capture process, the carbon transportation system, and the carbon usage system. Such a model may be used, for example, to produce a design for a plant such as an integrated gasification combined cycle (IGCC) power plant and/or a design for a carbon capture process. The model may also be used to create the operational processes suitable to operate the carbon emitting plant, the carbon capture process, the carbon transportation system, and/or the carbon usage system (e.g., EOR). Further, the model may be used to optimize operations for each or for all of the aforementioned systems. Additionally, the model may be used to retrofit a system such as the carbon capture process into an existing plant, as described in more detail below. Accordingly, the carbon emission, capture, transport, and usage model may include a plurality of sub models, such as a carbon capture model, a carbon emission model, a carbon transport model, and/or a carbon usage model.

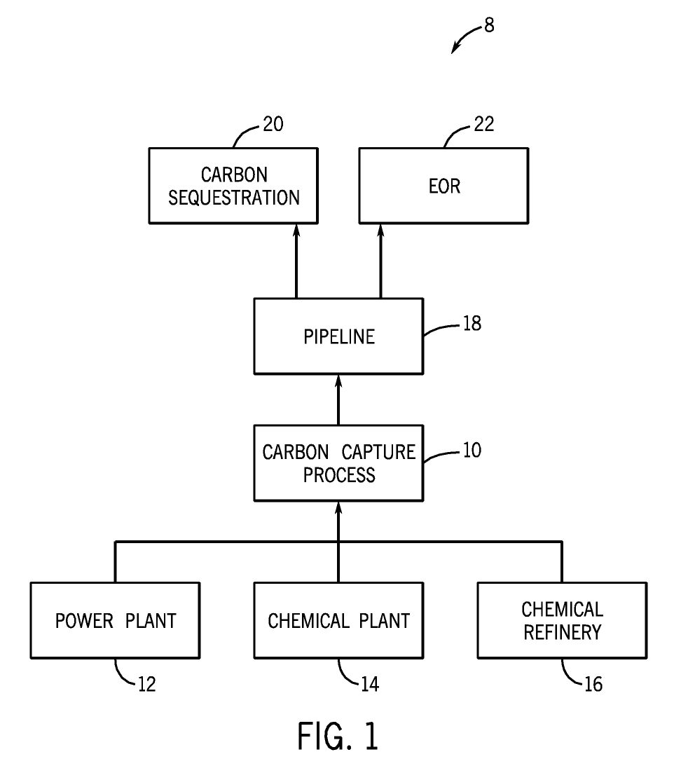

In certain embodiments, each of the carbon capture model, the carbon emission model, the carbon transport model, and the carbon usage model may be capable of steady-state and/or dynamic modeling of the capabilities and parameters of the respective systems being modeled. A plurality of modeling techniques useful in static and dynamic modeling may be used, for example, simulation models, mathematical models, process control models, and so forth. The models may be used to create design and process control modalities for the various systems described in FIG. 1 below.

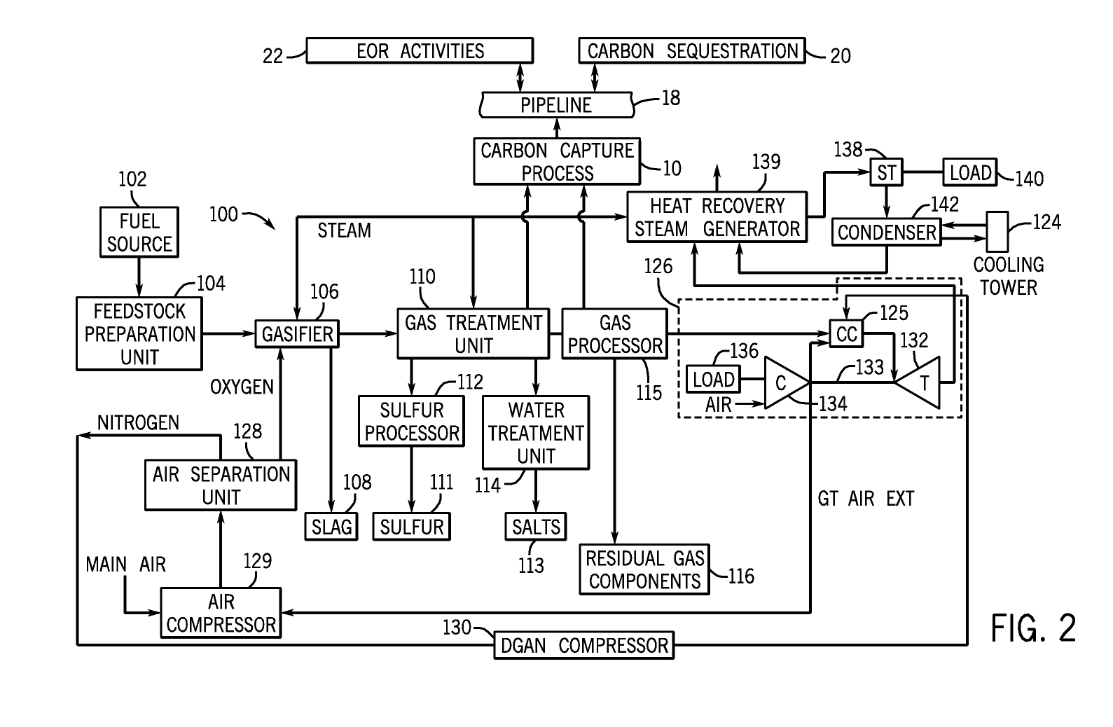

With the foregoing in mind, it may be beneficial to discuss embodiments of systems that may incorporate the techniques as described herein before discussing details of the model. FIG. 1 depicts a block diagram of an embodiment of interoperable systems 8. More specifically, the diagram depicts an embodiment of a carbon capture process (CCP) 10 suitable for interoperating with embodiments of a power plant 12, a chemical production plant 14, and a chemical refinery plant 16, among others. An example of such a CCP 10 is manufactured by General Electric Company of Schenectady, N.Y., under the designation GE Carbon Island™. In the depicted embodiment, each of the power plant 12, the chemical production plant 14, and the chemical refinery plant 16 is capable of producing a product having a carbonaceous substance (e.g., CO₂). Extraction of the carbonaceous substance from the product may be beneficial, for example, to help reduce or to prevent greenhouse emissions. Accordingly, the CCP 10 may be used to extract the CO₂ from various types of industrial plants, such as plants 12, 14, and 16. Indeed, a plurality of embodiments of the CCP 10 may be made available so as to optimally operate in conjunction with each of the plants 12, 14, and 16. That is, each plant 12, 14, and 16, may operate with a separate CCP 10 embodiment that may have been adapted to optimally work with that particular plant embodiment. For example, the CCP 10 embodiment depicted in FIG. 2 may be designed and/or retrofitted, using the techniques described herein, so as to optimally operate with an embodiment of an integrated gasification combined cycle (IGCC) power plant.

The CCP 10 is also capable of interoperating with a pipeline system 18 so as to transport the extracted CO₂ for use, for example, by the carbon sequestration facility 20, and/or the EOR activities 22. In certain embodiments, the carbon sequestration facility 20 may include a geological formation such as a saline aquifer. In other embodiments, other types of geological formations may be used. The EOR activities may include oil well recovery activities such as gas injection. The gas injection activity can inject the extracted CO₂ at high pressures so as to displace subsurface oil. Indeed, the CO₂ extracted by the CCP 10 may have many beneficial uses and may be sold.

FIG. 2 depicts an IGCC power plant 100 embodiment of a power plant 12. In the depicted embodiment, the IGCC power plant 100 may produce and burn a synthetic gas, i.e., a syngas. Elements of the IGCC power plant 100 may include a fuel source 102, such as a carbonaceous feedstock, that may be utilized as a source of energy for the IGCC power plant 100. The fuel source 102 may include coal, petroleum coke, biomass, wood-based materials, agricultural wastes, tars, oven gas, orimulsion, lignite, and asphalt, or other carbon containing items.

The fuel of the fuel source 102 may be passed to a feedstock preparation unit 104. The feedstock preparation unit 104 may, for example, resize or reshape the fuel source 102 by chopping, milling, shredding, pulverizing, briquetting, or palletizing the fuel source 102 to generate feedstock. Additionally, water, or other suitable liquids may be added to the fuel source 102 in the feedstock preparation unit 104 to create slurry feedstock. In certain embodiments, no liquid is added to the fuel source, thus yielding dry feedstock. The feedstock may be conveyed into a gasifier 106 for use in gasification operations.

The gasifier 106 may convert the feedstock into a syngas, e.g., a combination of carbon monoxide and hydrogen. This conversion may be accomplished by subjecting the feedstock to a controlled amount of any moderator and limited oxygen at elevated pressures (e.g., from approximately 600 pounds per square inch gauge (PSIG)-1200 PSIG) and elevated temperatures (e.g., approximately 2200° F.-2700° F.), depending on the type of feedstock used. The heating of the feedstock during a pyrolysis process may generate a solid (e.g., char) and residue gases (e.g., carbon monoxide, hydrogen, and nitrogen).

A combustion process may then occur in the gasifier 106. The combustion may include introducing oxygen to the char and residue gases. The char and residue gases may react with the oxygen to form CO₂ and carbon monoxide (CO), which provides heat for the subsequent gasification reactions. The temperatures during the combustion process may range from approximately 2200° F. to approximately 2700° F. In addition, steam may be introduced into the gasifier 106. The gasifier 106 utilizes steam and limited oxygen to allow some of the feedstock to be burned to produce carbon monoxide and energy, which may drive a second reaction that converts further feedstock to hydrogen and additional carbon dioxide.

In this way, a resultant gas is manufactured by the gasifier 106. This resultant gas may include approximately 85% of carbon monoxide and hydrogen in equal proportions, as well as Argon, CH₄, HCl, HF, COS, NH₃, HCN, and H₂S (based on the sulfur content of the feedstock). This resultant gas may be termed untreated syngas, since it contains, for example, H₂S. The gasifier 106 may also generate waste, such as slag 108, which may be a wet ash material. This slag 108 may be removed from the gasifier 106 and disposed of, for example, as road base or as another building material. To treat the untreated syngas, a gas treatment unit 110 may be utilized. In one embodiment, the gas treatment unit 110 may include one or more water gas shift reactors. The water gas shift reactors may aid in elevating the level of hydrogen (H₂) and CO₂ in the fuel by converting the CO and H₂O in the syngas into CO₂ and H₂ (e.g., sour shifting). The gas treatment unit 110 may also scrub the untreated syngas to remove the HCl, HF, COS, HCN, and H₂S from the untreated syngas, which may include separation of sulfur 111 in a sulfur processor 112 component of the gas treatment unit 110. Furthermore, the gas treatment unit 110 may separate salts 113 from the untreated syngas via a water treatment unit 114 that may utilize water purification techniques to generate usable salts 113 from the untreated syngas. Subsequently, the gas from the gas treatment unit 110 may include treated syngas, (e.g., the sulfur 111 has been removed from the syngas), with trace amounts of other chemicals, e.g., NH₃ (ammonia) and CH₄ (methane).

A gas processor 115 may be used to remove additional residual gas components 116, such as ammonia and methane, as well as methanol or any residual chemicals from the treated syngas. Argon may also be recovered. Argon is a valuable product which may be recovered using, for example, cryogenic techniques. However, removal of residual gas components from the treated syngas is optional, since the treated syngas may be utilized as a fuel even when containing the residual gas components, e.g., tail gas.

The carbon capture process 10 may extract and process the carbonaceous gas, e.g., CO₂. The CCP 10 may interoperate with the gas treatment unit 110, including the sulfur processor 112, to remove CO₂ from the syngas before combustion (i.e., pre-combustion extraction). Additionally, carbon capture techniques may be used to extract CO₂ after combustion of the syngas (i.e., post-combustion extraction). Further, combustion techniques may be used to aid in removing the CO₂ during combustion (i.e., modified combustion). Some example techniques for CO₂ extraction that include pre, post, and modified combustion modalities are as follows. Physical absorption techniques may be used that employ a physical solvent such as Selexol™ Purisol™, or Rectisol™, among others, during an acid gas reduction (AGR) process in the sulfur processor 112 to dissolve acid gases, such as H₂S, and CO₂ from the syngas. The H₂S and CO₂ rich liquor may then be further processed to remove and separate the H₂S and the CO₂, for example by using a regeneration vessel (e.g., stripper). Chemical absorption techniques may be used that employ amines, caustics and other chemical solvents to scrub, for example, a cooled flue gas that is brought into contact with the solvent. The CO₂ may then become bound into the chemical solvent. The enriched solvent may then be caused to release the CO₂ by techniques such as the aforementioned regeneration vessel.

Physical adsorption techniques may also be used wherein solid sorbents, such as sorbents based on zeolites, silica, and so forth, bind the CO₂ such as the CO₂ in the flue gas so as to remove the CO₂ from the flue gas. Chemical adsorption techniques employing, for example, metal oxides may also be used in a similar manner. Membrane-based techniques may also be used, wherein plastics, ceramics, metals, and so forth are used as permeable barrier to separate the CO₂ from a flow containing the CO₂. Modified combustion techniques such as oxy-fuel and chemical looping may also be used to extract the CO₂. In oxy-fuel, approximately pure oxygen is used in lieu of air as the primary oxidant. The fuel is combusted in the oxygen so as to produce a flue gas rich in CO₂ and water vapor. The CO₂ may then be more easily extracted from the flue gas and water vapor. The use of oxygen also reduces the nitrous oxides (NOx) that may be produced when using air. In chemical looping, dual fluidized bed systems employing, for example, a metal oxide are used to extract CO₂. The metal oxide works as a bed material providing oxygen for combustion. Oxygen replaces air as an oxidant and is used to combust the fuel. CO₂ extraction techniques may more easily extract the flue gas rich in CO₂. The subsequently reduced metal is transferred to the second bed to re-oxidize. The re-oxidized metal is then reintroduced into the first bed and again used for combustion, closing the loop. Cryogenic techniques capable of cooling flue gas to desublimation temperatures (e.g., approximately −100° C. to −135° C.) may be used. Solid CO₂ may form due to the cooling, and is subsequently removed from the flue stream. Indeed, any number and combination of carbon capture techniques, such as the aforementioned techniques, may be included in the carbon capture process 10. The CO₂ may then be compressed and dehydrated. For example, the CO₂ may be compressed to high pressures (e.g., approximately upwards of 2200 PSI), and liquefied. The high pressure, liquefied CO₂ may then be transported by a pipeline system 18. The CO₂ may then be redirected into the carbon sequestration system 20, and/or the EOR 22. Accordingly, emissions of the extracted CO₂ into the atmosphere may be reduced or eliminated by redirecting the extracted CO₂ for other uses.

In certain embodiments, the IGCC plant 100 may be designed to incorporate the carbon capture process 10. In other embodiments, the IGCC plant 100 may be retrofitted to add the carbon capture process 10. Indeed, it is possible to retrofit the CCP 10 to a variety of existing IGCC plants 100. The retrofitted CCP 10 may include integration with existing AGR processes and may be installed as part of a gas turbine engine 126 or the gasifier 106 maintenance. In some retrofit embodiments, increased AGR capacity is added to the IGCC plant 100 so as to allow for larger amounts of CO₂ capture. Shift reactors may also be added during retrofit to increase the CO₂ in the syngas, with a corresponding increase in H₂. Additionally, the gas turbine engine 126 may be upgraded during the retrofit to operate more efficiently with the increased H₂ that may be present in the syngas after CO₂ extraction.

Continuing with the syngas processing, once the CO₂ has been captured from the syngas, the treated syngas may be then transmitted to a combustor 125, e.g., a combustion chamber, of the gas turbine engine 126 as combustible fuel. The IGCC power plant 100 may further include an air separation unit (ASU) 128. The ASU 128 may operate to separate air into component gases by, for example, distillation techniques. The ASU 128 may separate oxygen from the air supplied to it from a supplemental air compressor 129, and the ASU 128 may transfer the separated oxygen to the gasifier 106. Additionally the ASU 128 may transmit separated nitrogen to a diluent nitrogen (DGAN) compressor 130.

The DGAN compressor 130 may compress the nitrogen received from the ASU 128 at least to pressure levels equal to those in the combustor 125, so as not to interfere with the proper combustion of the syngas. Thus, once the DGAN compressor 130 has adequately compressed the nitrogen to a proper level, the DGAN compressor 130 may transmit the compressed nitrogen to the combustor 125 of the gas turbine engine 126. The nitrogen may be used as a diluent to facilitate control of emissions, for example.

As described previously, the compressed nitrogen may be transmitted from the DGAN compressor 130 to the combustor 125 of the gas turbine engine 126. The gas turbine engine 126 may include a turbine 132, a drive shaft 133 and a compressor 134, as well as the combustor 125. The combustor 125 may receive fuel, such as syngas, which may be injected under pressure from fuel nozzles. This fuel may be mixed with compressed air as well as compressed nitrogen from the DGAN compressor 130, and combusted within combustor 125. This combustion may create hot pressurized exhaust gases.

The combustor 125 may direct the exhaust gases towards an exhaust outlet of the turbine 132. As the exhaust gases from the combustor 125 pass through the turbine 132, the exhaust gases force turbine blades in the turbine 132 to rotate the drive shaft 133 along an axis of the gas turbine engine 126. As illustrated, the drive shaft 133 is connected to various components of the gas turbine engine 126, including the compressor 134.

The drive shaft 133 may connect the turbine 132 to the compressor 134 to form a rotor. The compressor 134 may include blades coupled to the drive shaft 133. Thus, rotation of turbine blades in the turbine 132 may cause the drive shaft 133 connecting the turbine 132 to the compressor 134 to rotate blades within the compressor 134. This rotation of blades in the compressor 134 causes the compressor 134 to compress air received via an air intake in the compressor 134. The compressed air may then be fed to the combustor 125 and mixed with fuel and compressed nitrogen to allow for higher efficiency combustion. Drive shaft 133 may also be connected to a load 136, which may be a stationary load, such as an electrical generator for producing electrical power, for example, in a power plant. Indeed, the load 136 may be any suitable device that is powered by the rotational output of the gas turbine engine 126.

The IGCC power plant 100 also may include a steam turbine engine 138 and a heat recovery steam generation (HRSG) system 139. The steam turbine engine 138 may drive a second load 140. The second load 140 may also be an electrical generator for generating electrical power. However, both the first and second loads 136, 140 may be other types of loads capable of being driven by the gas turbine engine 126 and steam turbine engine 138. In addition, although the gas turbine engine 126 and steam turbine engine 138 may drive separate loads 136 and 140, as shown in the illustrated embodiment, the gas turbine engine 126 and steam turbine engine 138 may also be utilized in tandem to drive a single load via a single shaft. The specific configuration of the steam turbine engine 138, as well as the gas turbine engine 126, may be implementation-specific and may include any combination of sections.

The system 100 may also include the HRSG 139. Heated exhaust gas from the gas turbine engine 126 may be transported into the HRSG 139 and used to heat water and produce steam used to power the steam turbine engine 138. Exhaust from, for example, a low-pressure section of the steam turbine engine 138 may be directed into a condenser 142. The condenser 142 may utilize the cooling tower 124 to exchange heated water for chilled water. The cooling tower 124 acts to provide cool water to the condenser 142 to aid in condensing the steam transmitted to the condenser 142 from the steam turbine engine 138. Condensate from the condenser 142 may, in turn, be directed into the HRSG 139. Again, exhaust from the gas turbine engine 126 may also be directed into the HRSG 139 to heat the water from the condenser 142 and produce steam.

In combined cycle power plants such as IGCC power plant 100, hot exhaust may flow from the gas turbine engine 126 and pass to the HRSG 139, where it may be used to generate high-pressure, high-temperature steam. The steam produced by the HRSG 139 may then be passed through the steam turbine engine 138 for power generation. In addition, the produced steam may also be supplied to any other processes where steam may be used, such as to the gasifier 106. The gas turbine engine 126 generation cycle is often referred to as the “topping cycle,” whereas the steam turbine engine 126 generation cycle is often referred to as the “bottoming cycle.” By combining these two cycles as illustrated in FIG. 1, the IGCC power plant 100 may lead to greater efficiencies in both cycles. In particular, exhaust heat from the topping cycle may be captured and used to generate steam for use in the bottoming cycle.

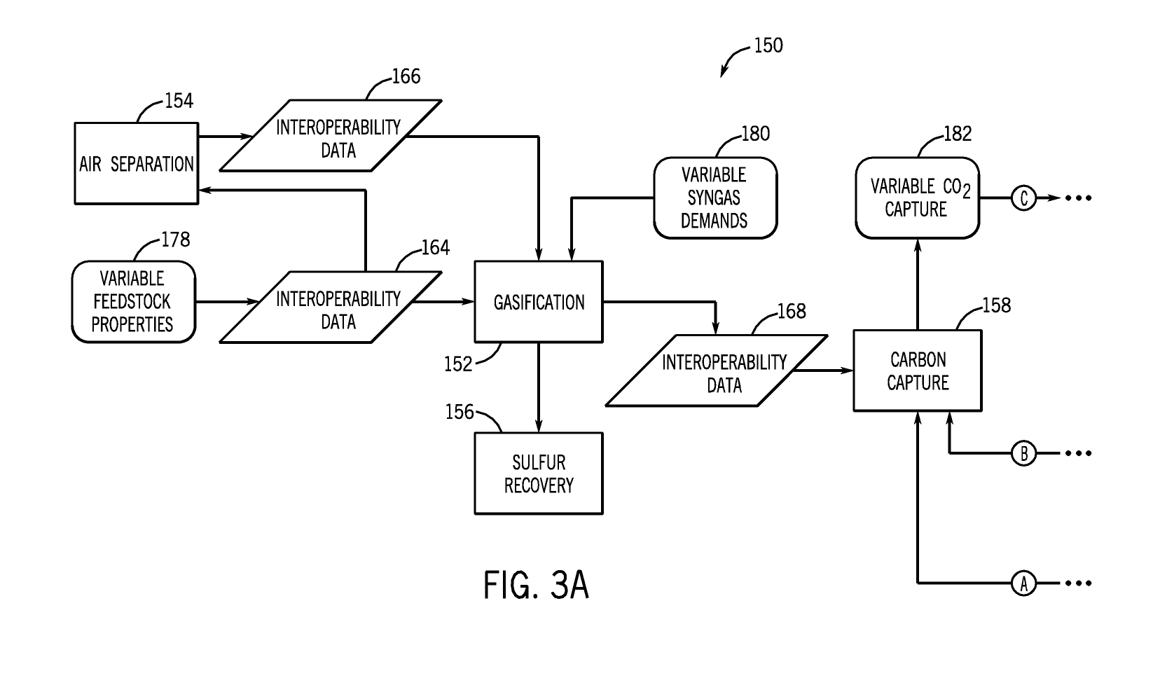

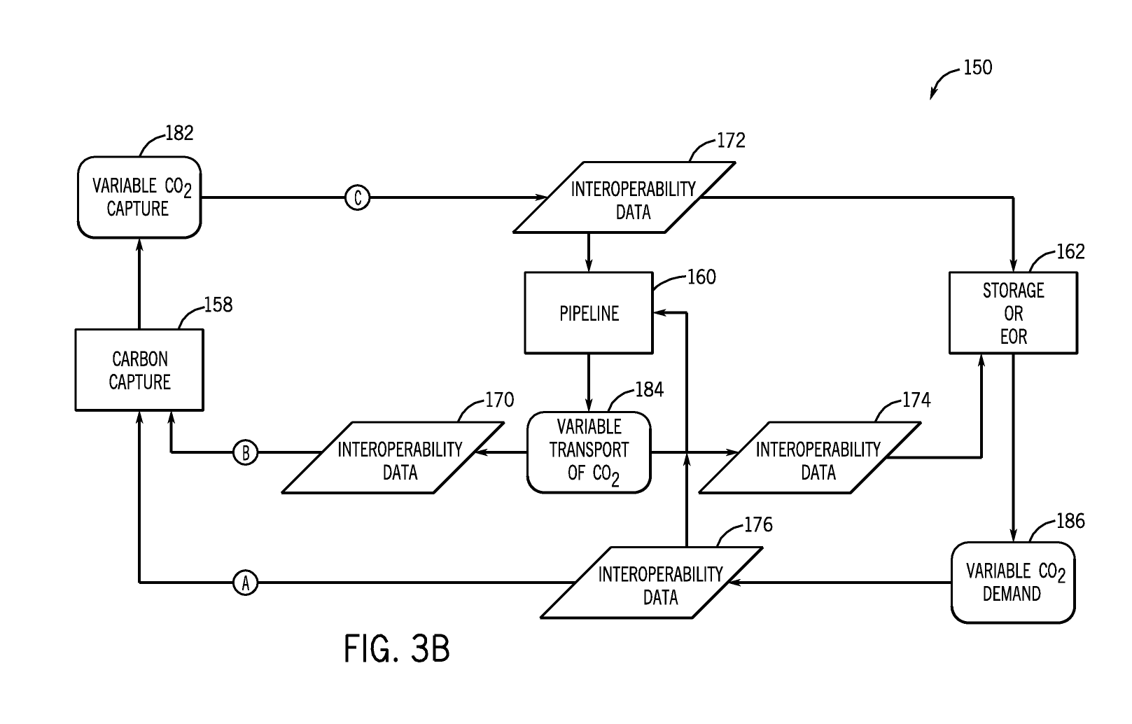

FIGS. 3A and 3B depict an embodiment of a carbon emission, capture, transport, and usage model 150. In the depicted embodiment, the carbon emission, capture, transport, and usage model 150 may be used to capture the interrelationships (e.g., inputs, outputs, and requirements) between systems such as the CCP 10, the pipeline system 18, the CO₂ sequestration system 20 and/or the EOR 22. The model 150 may then be used, for example, to operate, design, build, retrofit, optimize, and permit (i.e., procure regulatory license for) a plant, such as the IGCC plant 100, so as to more efficiently interoperate with various systems, including downstream systems such as the pipeline system 18, the CO₂ sequestration system 20, and/or the EOR system 22. Additionally, the model 150 may include machine readable code or computer instructions that may be used by a computing device (e.g., computer workstation), for example, to transform documents and other data into an interoperable design, simulation, or process control embodiment (i.e., logic executable by a controller) suitable for building and controlling a plant, such as the IGCC power plant 100. Indeed, by detailing a plurality of interoperability data and by using modeling techniques described herein, the model 150 may be used to build, retrofit and/or operate a plant capable of capturing variable levels of CO₂ and capable of interoperating with other systems so as to efficiently transport and use the captured CO₂.

In one embodiment, the model 150 includes a plurality of sub models, such as a carbon emission (e.g., gasification) model 152, an air separation model 154, a sulfur recovery model 156, a carbon capture model 158, a carbon transport (e.g., pipeline) model 160, and a carbon usage (e.g., storage or EOR) model 162. Each of the models, 150-162 may include logic components, document components, data components, and so forth, useful in describing their respective system as well as the interrelationships between systems. Additionally, the logic components of each model 150-162 may include machine readable code or computer instructions that may be used by a computing device, to transform documents and other data into an interoperable design, simulation, or process control embodiment suitable for building and controlling their respective systems.

Interoperability data, such as interoperability data 164, 166, 168, 170, 172, 174, and 176, may be used to aid in defining the inputs, outputs, and interrelationships between the models 150-162. Additionally, model variables, such as model variables 178, 180, 182, 184, and 186, may be used to define properties and/or specifications that may vary according to conditions such as economic conditions (e.g., market demand, transportation costs, construction costs), engineering conditions (e.g., retrofit space, available fuel type), regulatory conditions (e.g., state law, federal law), and so forth. The model variables 178-186 may then be used to produce a new set of interoperability data 164-176 suitable for defining a set of inputs, outputs, and interrelationships between the models 150-162, as illustrated. Such dynamic capabilities of the model 150 allow the model 150 to be tailored to a plurality of conditions, both regulatory, technical as well as economic.

With the foregoing in mind and turning now to an embodiment of a section of the model 150 illustrated in FIG. 3A, the illustrated section depicts the interrelationship between the gasification model 152, the air separation model 154, and the carbon capture model 158. The air separation model 154 is capable of defining design and process control modalities, among others, corresponding to the ASU 128 and related components as described with respect to FIG. 2 above. In one example, the design modalities may include custom built software that is capable of simulating the ASU 128. Commercial off-the shelf (COTS) simulation packages such as Aspen Plus™, HYSYS®, PRO/II™, gPROMS, CHEMCAD™, Mathlab®, Mathematica®, and so forth, may also be used standalone or in combination with the custom software to model the air separation model 154. That is, the software is capable of building a simulation model based on a specific design of the ASU 128. The simulation model may then simulate the ASU 128 design and calculate a plurality of ASU 128 parameters useful for determining the efficiency of the design as well as the interoperability of the design. The ASU simulation model may include a steady state model, a dynamic simulation model, and others, capable of simulating the separation of a gas (e.g., oxygen) and producing a plurality of output parameters. Such parameters are illustrated as interoperability data 166, and include oxygen purity, oxygen pressures, oxygen flow rates, and so forth. Additionally, variable feedstock properties 178, such as the type of fuel used (coal, lignite, biomass), may result in interoperability data 164 being used as one of a set of inputs to the air separation simulation model 154. The interoperability data 164 may include the composition of the feedstock (e.g., mole percentage of C, H, N, S, O), heating value of the feedstock (e.g., measure of energy contained in the fuel), specific gravity of the feedstock, feedstock economic data (e.g., fuel cost, transportation cost), and so forth. The interoperability data 164 may then be used by the air separation simulation model 154 to arrive at an optimal and interoperable design for the ASU 128. The design may then be used to produce drawings, such as CAD drawings, piping layouts, manufacturing instruction lists, bill of materials (BOM), and so forth, suitable for building, optimizing or retrofitting the ASU. Indeed, all of the models 150-162 are capable of similar design modalities for each of their respective systems.

In another embodiment, the air separation model 154 may include process control modalities that can be used by a controller to control the ASU 128. Accordingly, process control models such as dynamic matrix control models (DMC), proportional-integral-derivative (PID) models, linear control models, non-linear control models, open-loop control models, and so forth, may be used. Such models may be defined, for example, by using the simulation models included in the air separation model 154 and incorporating process control models simulations. For example, a simulated DMC controller may be incorporated into the simulation model 154 and the simulated DMC controller may be programmed to control the simulation model 154. Various process control programs may be simulated and tested in order to arrive at an efficient process control program. The software instructions used to control the simulated DMC controller may then be used by a physical DMC controller to control the ASU 128. Further, all of the models 150-162 are capable of process control modalities for their respective systems. Accordingly, the interoperability data 164-176 may include process control data, such as distributed process control data, that allow the various systems to interoperate. In the illustrated example, the interoperability data 166 may include sensor data from the ASU 128 indicative of current gas properties for the gases being separated by the ASU 128. The sensor data may then be used by the gasifier 106, for example, to modify gasification combustion. Indeed, such process control interoperability may increase the overall efficiency of the IGCC plant 100.

Continuing with the model 150, the model 150 includes the gasification model 152 capable of having design and process control modalities directed to the gasifier 106 and related components. Accordingly, the gasification model 152 may include custom built software and/or COTS software capable of simulating the gasification process, including the production of syngas. For example, the model 152 may include steady state and/or dynamic simulation models suitable for simulating various types of gasifiers 106, such as an entrained flow gasifiers, fluidized bed gasifiers, moving bed gasifiers, and so forth. Indeed, any type of gasifier design may be modeled by the model 152. Air separation interoperability data 164, feedstock properties interoperability data 166, and model variable 180 (e.g., syngas demands) may be used as inputs to the gasification model 152 to aid in optimally designing the gasifier 106 and related components.

For example, the interoperability data 164, 166 may be used to define the oxidant and feedstock specifications (e.g., composition, O₂ pressure, flow volumes) used as inputs to simulations such as high-fidelity computational fluid dynamics (CFD) simulations of the gasifier 106. Additionally, model variables 180 may be used to define operational demands for syngas, among others. For example, the operational demands may include a syngas amount suitable for use by the gas turbine engine 126, a syngas amount that may be sold, a syngas amount that may be further processed, for example, into diesel, and so forth. The gasification simulation model 152 may then be employed to determine optimal gasification temperatures, pressures, moderator flow volumes, syngas composition, and so forth. The design of the gasifier 106 capable of efficient operations may then be used to produce a set drawings, such as CAD drawings, piping layouts, manufacturing instruction lists, bill of materials (BOM), and so forth, suitable for constructing and/or retrofitting a gasifier 106 and related components. Additionally, the simulation model 152 outputs may be used as the gasification interoperability data 168. Indeed, the gasification interoperability data 168 may be used by the carbon capture model 158 to increase plant efficiency.

In other embodiments, the gasification model 152 may include operational modalities that can be used by a controller to control the gasifier 106 and related components. As mentioned above, a plurality of process control models such as DMC models, PID models, linear control models, non-linear control models, open-loop control models, and so forth, may be used. Indeed, the process control models may be created by simulating controllers, such as DMC controllers, that control various simulation models 152. A plurality of simulated DMC controllers may be programmed to control the simulations. An efficient simulated DMC controller may then be selected and the resulting programs of the simulated DMC controller may be transferred to the physical DMC controllers capable of controlling the gasifier 106 and related components.

A sulfur recovery model 156 is also illustrated. In one embodiment, the sulfur recovery model 156 may include custom built software and/or COTS software capable of simulating the recovery of sulfur, including simulating the sulfur processor 112, for design purposes. When the IGCC plant 100 does not incorporate a CCP 10, or when some CO₂ is to be left in the syngas, the sulfur recovery model may simulate a selective removal of sulfur 111, leaving some or all of the CO₂ in the syngas. For example, the CO₂ may be retained by first absorbing the CO₂ in the AGR process and then desorbing the CO₂ from the absorber liquor. The retained CO₂ may increase power production in the gas turbine engine 126 as well as suppress some NOx formation. If desired, the CO₂ could then be extracted using post-combustion techniques. If the IGCC plant 100 incorporates a CCP 10, the sulfur recovery simulation model 156 may simulate an AGR process with some modifications such as the removal of the desorption process of CO₂ to allow the CCP 10 to extract and compress the CO₂, as detailed below. The simulation model 156 may then be used to select an efficient and interoperable design for the sulfur processor 110. The sulfur processor 112 may be optimized, built and/or retrofitted with the aid of engineering drawings such as CAD drawings, piping layouts, manufacturing instruction lists, bill of materials (BOM), and so forth.

In one embodiment, the sulfur recovery model 156 may include operational modalities such as DMC models, PID models, linear control models, non-linear control models, open-loop control models, and so forth. Such modalities may be simulated, and the simulation used to define the programming for a plurality of simulated DMC controllers, as described above. An efficient DMC controller may then be determined and used in the IGCC plant to control the sulfur processor 112.

FIG. 3B is illustrative of a downstream section of an embodiment of the model 150, including the carbon capture model 158, the carbon transport model 160, and the carbon usage model 162. As mentioned above with respect to FIG. 3A, the carbon capture model 158 is capable of utilizing a set of gasification interoperability data 168 as input. Additionally, interoperability data 170 produced by the transport of CO₂ model variable 184 and the interoperability data 176 produced by the CO₂ demand model variable 186 may also be used as input. The interoperability data 170 includes data related to the pipeline system 18, including current pipeline capacity, pipeline transportation costs, pipeline availability, and so forth. The interoperability data 176 includes data related to the carbon sequestration system 20 and/or the EOR 22. Such data 176 may include market price for CO₂, available storage capacity in tons, available usage capacity in tons, preferred CO₂ intake pressures, and so forth.

The carbon capture model 158 is capable of defining design and process control modalities, among others, corresponding to the CCP 10 and related components. Accordingly, the model 158 may include simulation models, such as pre-combustion carbon capture models, post-combustion carbon capture models, and modified combustion carbon capture models, suitable for simulating various types of carbon capture technologies. For example, the pre-combustion models 158 may include physical absorption models and membrane models, among others. The post-combustion models 158 may include chemical absorption and chemical adsorption, membrane models, cryogenic models, and others. The modified combustion models 158 may include oxy-fuel combustion models and chemical looping models, among others.

In one embodiment, the various simulation models included in the carbon capture model 158 may be created by using custom software, COTS software, or a combination thereof. The simulation models may be suitable for simulating the CCP 10, including calculating various parameters for a given design of a CCP 10. The parameters may include a CO₂ volume, a CO₂ flow rate, a percentage removal of CO₂, a total energy used by the CCP 10, an energy used per mole of CO₂ extracted, and so forth. An efficient, interoperable CCP 10 design may be arrived at by using the carbon capture model 158. Accordingly, the CO₂ capture model variables 182 may include interoperability data 172 corresponding to the aforementioned simulation outputs. Further, the carbon capture model 152 is able to interoperate with the aforementioned upstream models 152-156 so as to simulate and design the entirety of the IGCC 100 plant. Consequently, the model 150 may determine a plurality of specifications for an industrial plant, such as the IGCC plant 100, including production power capacity (e.g., megawatts), combined power cycle efficiency, water utilization, feedstock intake lb/hr, argon production, sulfur production, methane production, ammonia production, O₂ usage for gasification, and so forth. Accordingly, the CCP 10 may be built, retrofitted and/or permitted so as to interoperate with an industrial plant such as the IGCC plant 100.

In one embodiment, the carbon capture model 158 may include operational modalities such as DMC models, PID models, linear control models, non-linear control models, open-loop control models, and so forth, as mentioned above. Such modalities may be simulated, and the simulation used to define the programming for a physical controller, such as a DMC controller. The DMC controller may then be used in the IGCC plant to control the CCP 10. Indeed, the techniques disclosed herein allow for any type of industrial plant to be modeled with the carbon emission, capture, transport, and usage model 150 so as to operate, design, build, retrofit, optimize, and permit the plant and interrelated systems.

The model 150 may include the carbon transport model 160 so as to define interoperability with systems such as the pipeline system 18. In one example, the carbon transport model 160 may include custom built software that is capable of simulating the pipeline system 18. COTS pipeline and network simulation packages such as PROMAX®, PIPESYS™, Mathlab®, Mathematica®, and so forth, may also be used standalone or in combination with the custom software to model the carbon transport model 160. The simulation models may be capable of respecting pipeline specifications, such as moisture percentage, operating pressures, operating temperatures, and so forth. That is, the simulation models may be capable of taking into account certain pipeline specifications in the simulation so as to keep certain parameters within range of the specifications. Additionally, the simulation models may be capable of using piping network and/or graphical techniques so as to design pipeline networks specifically suited for CO₂ sequestration. Network and/or graphical techniques may include non-linear optimization modeling, linear optimization modeling, dynamic programming (e.g., single-period and multi-period cost functions), and so forth. The simulation model results may then be used to build the pipeline system 18 or to retrofit the CCP 10 into an existing pipeline system 18.

In one embodiment, the carbon transport model 158 may include operational modalities such as supervisory control and data acquisition (SCADA) models, DMC models, PID models, linear control models, non-linear control models, open-loop control models, and so forth, as mentioned above. Such modalities may be simulated, and the simulations used to define the programming for a physical controller, such as a SCADA controller. The SCADA controller may then be used to control the pipeline system 18.

A carbon usage model 162 may also be included in the model 150. The carbon usage model 162 may be used to model the usage and storage of carbon by systems such as the carbon sequestration system 20 and the EOR 22. In one embodiment, the EOR 22 may also be simulated so as to aid in realizing an efficient interoperability with a plant such as the IGCC plant 100 and the pipeline system 18. Accordingly, the carbon usage model 162 may include simulations for geological formations such as a saline aquifer and for EOR activities such as oil well gas injection. The simulations may use CO₂ capture interoperability data 172 for inputs to the simulations and provide outputs such as the CO₂ demand model variable 186. The model variable 186 may then result in the interoperability data 176 that may be used as inputs for the carbon capture model 158 and the carbon transport model 160. Indeed, by incorporating the downstream users of the CO₂, the model 150 may be capable of defining the full life cycle of the CO₂ produced by a plant, from production of the CO₂, capture of the CO₂, transportation of the CO₂, and sequestration or use of the CO₂. The breadth and depth of the interrelationships and systems being modeled by the model 150 may allow the use of the model 150 to increase systems interoperability, reduce cost, and increase operational efficiency across a plurality of plants having diverse carbon capture technologies. Indeed, the model 150 may substantially match supply and demand between the various systems, thereby reducing waste and improving overall efficiency. This may include supply and demand of CO₂ with very particular specifications, flow rates, etc., as well as syngas or other products with particular requirements. Some example interrelationship information, including interoperability requirements that may be entered into the model 150, is described in more detail below.

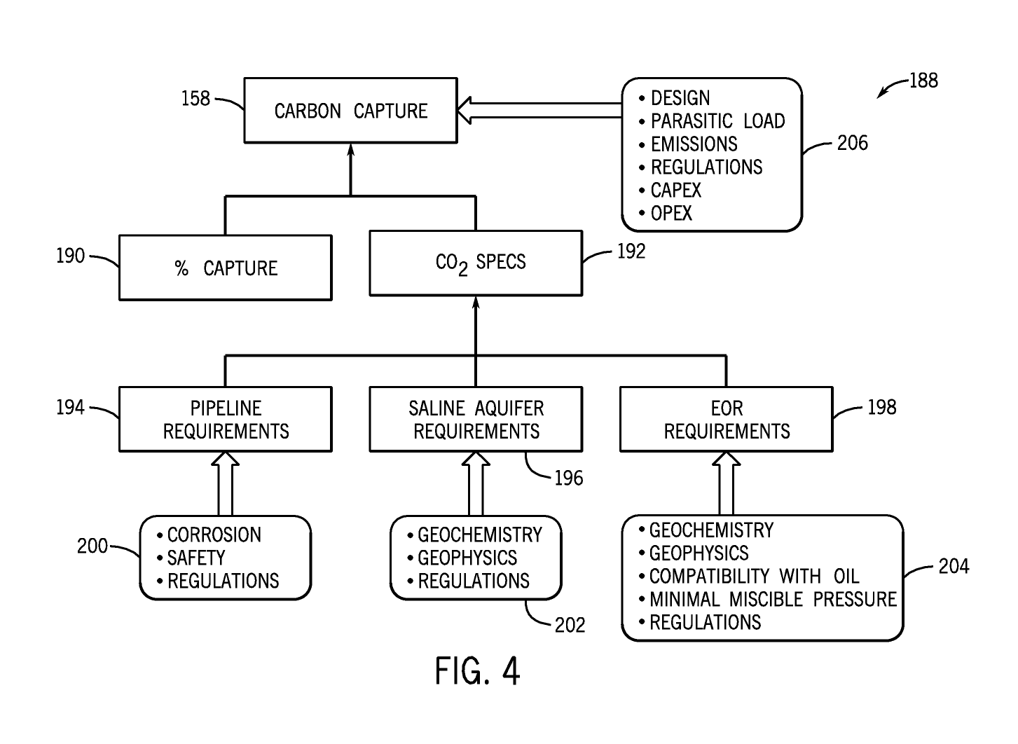

FIG. 4 illustrates an embodiment of a plurality of interrelationship data 188 that may be entered into the carbon capture model 158 and used, for example, as requirements to be approximated by the carbon capture model 158 when creating a design, build, retrofit and/or optimization of a plant such as the IGCC plant 100. The carbon capture model 158 is illustrated as including a percent capture requirement 190 and a CO₂ specification requirement 192. The percent capture requirement 190 details the capture percentage of CO₂ that is desired for the CCP 10. The percent capture requirement 190 may range between 0 to 100 percent carbon capture, e.g., equal to or greater than approximately 50, 60, 70, 80, 90, or 100% carbon capture. Indeed, some embodiments of the carbon capture model 158 may result in a “Greenfield” plant capable of approximately zero carbon emissions.

The CO₂ specification requirement may include a plurality of desired specifications for the CO₂ so as to aid in interoperability with other systems. Accordingly, pipeline requirements 194 may include corrosion, safety, and regulatory requirements 200. The corrosion requirements may include a desired CO₂ composition and a water content that aids in the prevention of pipeline corrosion. Safety requirements may include maximum operation pressures, temperatures, flow rates, and so forth, for improved safety of the CCP 10. Pipeline regulatory requirements may include state and federal regulation requirements that impact CO₂ transportation through the pipeline system 18. Saline aquifer requirements 196 may include geochemistry, geophysics, and regulatory requirements 202. The saline aquifer geochemistry requirements may include desired CO₂ composition requirements related to the geochemical nature of the saline aquifer used for storage. Such requirements may aid, for example, in improving the solubility of the CO₂ in the aquifer. The saline aquifer geophysical requirements may include desired CO₂ specifications, such as flow volumes and pressures, that relate to the geophysical formation of the saline aquifer. Saline aquifer regulatory requirements include CO₂ specifications so as to maintain compliance with the state and federal regulations that may govern the saline aquifer.

The EOR requirements 198 include geochemistry, geophysics, compatibility with oil, minimal miscible pressure, and regulatory requirements 204. The EOR geochemistry requirements may include desired CO₂ composition requirements related to the geochemical nature of, for example, an oil reservoir such as a Permian Basin reservoir. The EOR geophysical requirements may include desired CO₂ specifications, such as flow volumes and pressures that relate to the geophysical make up of the EOR. Compatibility with oil requirements include desired CO₂ specifications that may enhance how the CO₂ reacts with, for example, a type of oil such as West Texas Intermediate. Minimal miscible pressure (MMP) requirements include desired CO₂ specifications that may aid in achieving a desired solubility of the CO₂ and oil mixture. EOR regulatory requirements may detail desired CO₂ specifications related to the compliance of the EOR with state and federal regulations.

Design, parasitic load, emissions, regulations, CAPEX, and OPEX requirements 206 may also be used by the carbon capture model 158 to aid in the design, build, retrofit and/or optimization of a plant, such as the IGCC plant 100. Design requirements may include plant footage in square feet, desired technologies to be implemented (e.g., entrained gasification), retrofit constraints (e.g., reusing existing plant components and technology), and so forth. Parasitic load requirements may include desired energy limits on the energy used by the CCP 10. Emissions requirements may include requirements for limits on certain emissions such as NOx, SOx, particulate matter, and so forth. Carbon capture regulatory requirements include requirements related to the compliance of the CCP 10 with state and federal regulations. CAPEX, i.e., capital expenditure requirements, include desired budgetary constraints on capital equipment and similar purchases. OPEX, i.e., operating expenditures requirements, include desired budgetary constraints on the operating costs of running the CCP 10, including maintenance costs, personnel costs, and so forth. Accordingly, the carbon capture model 158 may then use the interrelationship data 188 to design, build, retrofit, operate, and optimize the CCP 10 that is more efficient, interoperable, and takes into account a plurality of interrelationships 188.

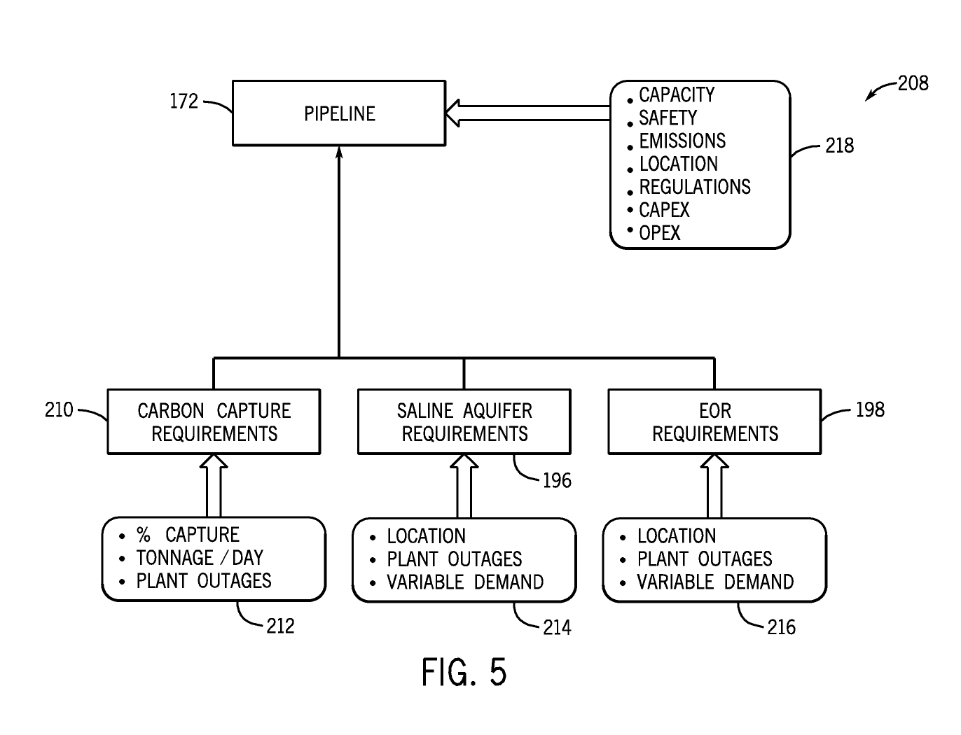

FIG. 5 illustrates an embodiment of a plurality of interrelationship data 208 that may be entered into the carbon usage model 172 and used, for example, as requirements to be approximated by the carbon usage model 172 when creating a design, build, retrofit and/or optimization of the pipeline system 18. Accordingly, improved interoperability and efficiency between systems may be achieved. Carbon capture requirements 210 include percentage capture, tonnage per day, and plant outages requirements 212. Percentage capture requirements include the desired percentage capture of the CCP 10. Tonnage per day requirements include an amount of CO₂ that may be produced by the CCP 10 and redirected into the pipeline system 18. CCP plant outages requirements include the capability of the pipeline system 18 to accommodate certain shutdowns and startups of the CCP 10.

Saline aquifer requirements 196 include location, plant outages, and variable demand requirements 214. Saline aquifer location requirements include a desired pipeline distance from the CCP 10 to the saline aquifer. Saline aquifer plant outages requirements include the ability of the pipeline system 18 to accommodate certain shutdowns and startups of the saline aquifer. Saline aquifer variable demand requirements include the capability of the pipeline system 18 to work with fluctuating demand for CO₂ from the saline aquifer.

EOR requirements 198 include location, plant outages, and variable demand requirements 216. EOR location requirements include a desired distance for the pipeline system 18 to transport CO₂ between the CCP 10 and the EOR 22. EOR plant outages requirements include the ability of the pipeline system 18 to work through certain shutdowns and startups of the EOR 22. EOR variable demand requirements include the capability of the pipeline system 18 to work with fluctuating demand for CO₂ from the EOR 22.

Capacity, safety, emissions, location, regulations, CAPEX, and OPEX requirements 218 may also be used by the carbon transport model 172 to aid in the design, build, retrofit and/or optimization of the pipeline system 18. Pipeline capacity requirements include pipeline flow rates and pressures. Pipeline safety requirements include maximum pressures, temperatures, flow rates, and others, useful in the safe operations of the pipeline. Pipeline emissions requirements include desired constraints on emissive discharges. Pipeline location requirements include desired locations to be traversed by the pipeline system 18. Pipeline regulatory requirements include desired pipeline construction, operation, and maintenance capable of maintaining state and federal regulatory compliance. CAPEX requirements include capital budgets, right-of-way budgets, and so forth, for the capitalization of the pipeline 18. OPEX requirements include operations and maintenance cost for the safe, reliable operations of the pipeline system 18. Accordingly, the carbon transport model 172 can then use the interrelationship data 208 to design, build, retrofit, operate, and optimize the pipeline system 18 that is more efficient, interoperable, and takes into account a plurality of interrelationships 208.

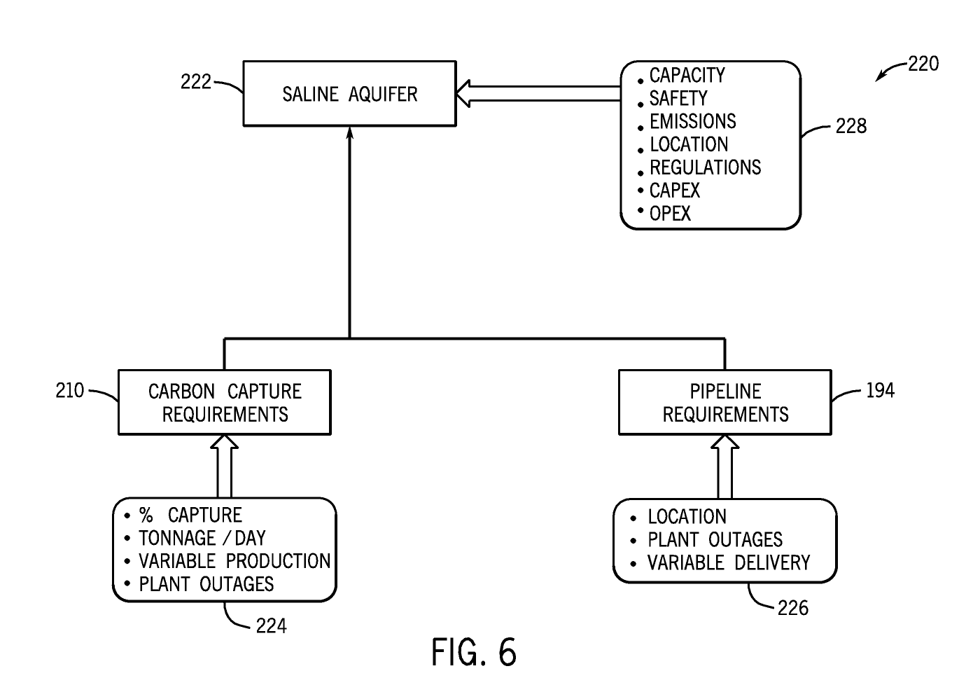

FIG. 6 illustrates an embodiment of a plurality of interrelationship data 220 that may be entered into a saline aquifer model 222 (e.g., submodel to the carbon usage model 162) and used, for example, as requirements to be approximated by the saline aquifer model 222 when creating a design, build, retrofit and/or optimization of the saline aquifer facility. Accordingly, improved interoperability and efficiency between systems may be achieved. Carbon capture requirements 210 include percentage capture, tonnage per day, variable production, and plant outages requirements 224. Carbon percentage capture requirements include the desired percentage capture of the CCP 10. Carbon tonnage per day requirements include an amount of CO₂ that may be produced by the CCP 10 and redirected into the saline aquifer for sequestration. CCP 10 plant outages requirements include the capability of the saline aquifer to accommodate certain shutdowns and startups of the CCP 10. Pipeline requirements 194 include location, plant outages, and variable delivery requirements 226. Pipeline location requirements include a desired distance that the pipeline system 18 may cover to transport CO₂ from the CCP 10 to the saline aquifer. Pipeline plant outages requirements include the ability of the saline aquifer to accommodate certain shutdowns and startups of the pipeline system 18.

Capacity, safety, emissions, location, regulations, CAPEX, and OPEX requirements 228 may also be used by the saline aquifer model 222 (e.g., submodel to the carbon usage model 162) to aid in the design, build, retrofit and/or optimization of the saline aquifer facility. Saline aquifer capacity requirements includes tonnage values, flow rates, and pressures capable of being used with the saline aquifer. Saline aquifer safety requirements include maximum pressures, temperatures, flow rates, and so forth. Saline aquifer emissions requirements include desired constraints on emissive discharges by the aquifer. Saline aquifer location requirements include desired locations for the saline aquifer. Saline aquifer regulatory requirements include desired saline aquifer operation and maintenance capable of maintaining state and federal regulatory compliance. CAPEX requirements include capital budgets, land-lease budgets, and so forth, for the capitalization of the saline aquifer 18. OPEX requirements include operations and maintenance cost for the safe, reliable operations of the saline aquifer.

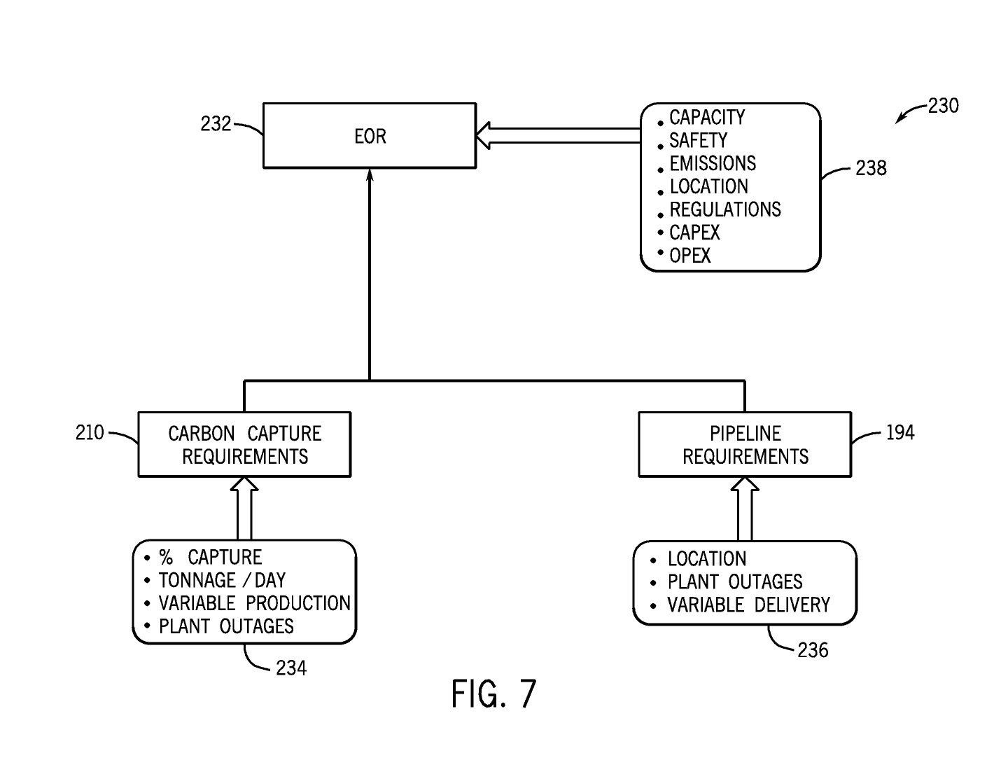

FIG. 7 illustrates an embodiment of a plurality of interrelationship data 230 that may be entered into a EOR model 232 (e.g., submodel to the carbon usage model 162) and used, for example, as requirements to be approximated by the EOR model 232 when creating a design, build, retrofit and/or optimization of the EOR 22. Accordingly, improved interoperability and efficiency between systems may be achieved. Carbon capture requirements 210 include percentage capture, tonnage per day, variable production, and plant outages requirements 234. Carbon percentage capture requirements include the desired percentage capture of the CCP 10. Carbon tonnage per day requirements include an amount of CO₂ that may be produced by the CCP 10 and redirected into the EOR 22. CCP 10 plant outages requirements include the capability of the EOR to accommodate certain shutdowns and startups of the CCP 10. Pipeline requirements 194 include location, plant outages, and variable delivery requirements 236. Pipeline location requirements include a desired distance that the pipeline system 18 may cover to transport CO₂ from the CCP 10 to the EOR 22. Pipeline plant outages requirements include the ability of the EOR 22 to accommodate certain shutdowns and startups of the pipeline system 18.

Capacity, safety, emissions, location, regulations, CAPEX, and OPEX requirements 238 may also be used by the EOR model 232 (e.g., submodel to the carbon usage model 162) to aid in the design, build, retrofit and/or optimization of the EOR 22. EOR capacity requirements includes tonnage values, flow rates and pressures capable of being used with the EOR. EOR safety requirements include maximum pressures, temperatures, flow rates, and so forth. EOR emissions requirements include desired constraints on emissive discharges by the EOR. EOR location requirements include desired locations for the EOR. EOR regulatory requirements include desired EOR operation and maintenance capable of maintaining state and federal regulatory compliance. CAPEX requirements include capital budgets, and so forth, for the capitalization of the saline aquifer 18. OPEX requirements include operations and maintenance cost and revenue for the safe, reliable operations of the EOR. Accordingly, the EOR model 232 can then use the interrelationship data 230 to design, build, retrofit, operate, and optimize a EOR 22 that is more efficient, interoperable, and takes into account a plurality of interrelationships 230.

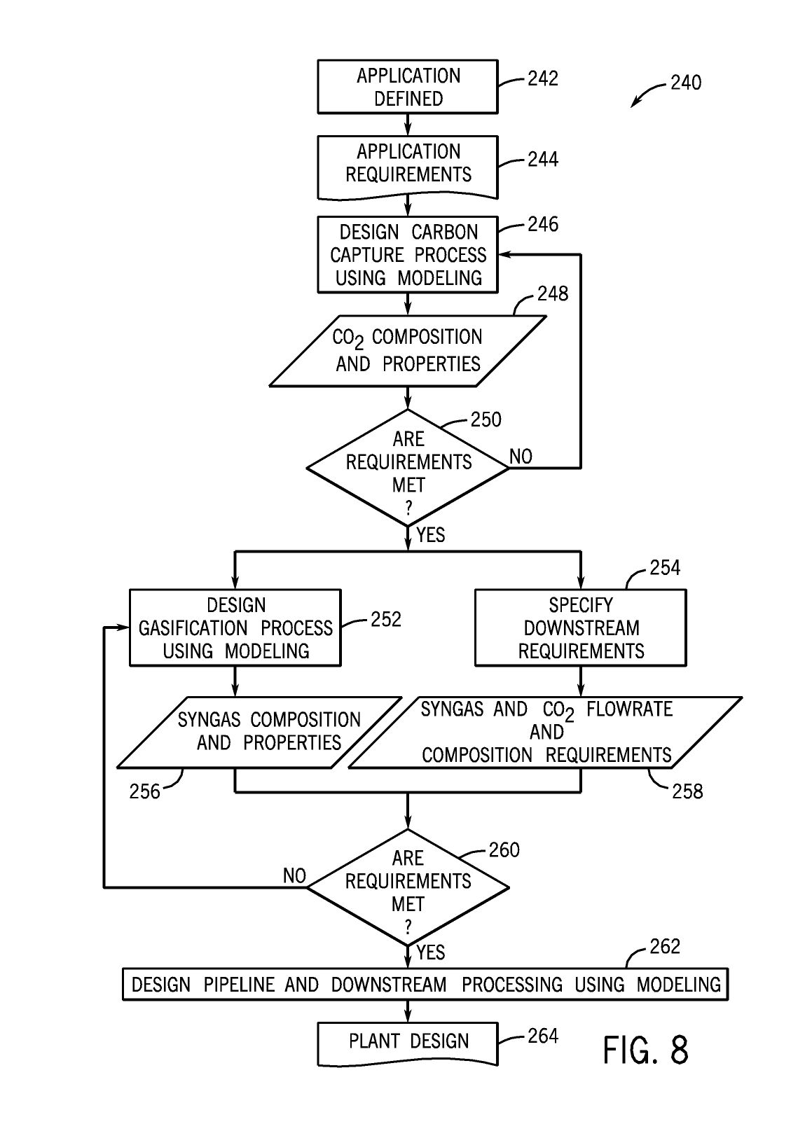

FIG. 8 is a flowchart depicting an embodiment of logic 240 that may be used in combination with the carbon emission, capture, transport, and usage model 150 so as to produce a plant design. The logic 240 may include machine readable code or computer instructions that may be used to enter data such as interoperability and requirements data, and to transform the entered data into, for example, the design of a plant. Indeed, by using the techniques described herein, it may be possible to efficiently design, retrofit, and/or operate the carbon emitting plant, CCP 10, pipeline system 18, carbon sequestration facility 20 and EOR 22.

The logic 240 is capable of defining an application (block 242). The application definition is useful in capturing the scope and breadth of the project, including desired power output capabilities, desired CO₂ capture goals (e.g., percentage of CO₂ captured), desired CO₂ flow rates through the pipeline system 18, desired usage for the transported CO₂, regulatory permit goals, and so forth. The application may be defined, for example, by selecting a project site for the IGCC power plant 100 and CCP 10, defining a forecast power demand (e.g., monthly demand, on-peak demand, off-peak demand), defining expected primary fuel, expected backup fuel, desired CO₂ capture percentage, and so forth. The definition of an application may also include defining usage sources for the storage and/or use of the captured CO₂. For example, a CO₂ sequestration facility 20 such as the saline aquifer may be chosen, and/or an EOR activity such the oil well reclamation (e.g., CO₂ injection) may be chosen. The application definition may also include defining CO₂ transportation facilities, such as new or existing pipeline systems 18, to be used in delivering the captured CO₂.

Consequently, the logic 240 may include a plurality of application requirements 244 that result from the application definition (block 242) of the logic 240. The application requirements 244 may be entered and stored in, for example, a requirements database, a spreadsheet, a text document, and so forth. The application requirements 244 may include, for example, the pipeline requirements 194, saline aquifer requirements 196, EOR requirements 198, carbon capture requirements 210, and other requirements 206, 218, 228 and 238, as described in more detail above with respect to FIGS. 4-7. Accordingly, the logic 240 is capable of storing a plurality of application requirements suitable for designing and/or retrofitting the carbon emitting plant (e.g., IGCC plant 100), the CCP 10, the carbon transportation system (e.g., pipeline system 18), and the carbon usage system (e.g., CO₂ sequestration system 20, EOR 22). Indeed, many of the stored application requirements 244 are requirements that impact interoperability between systems. For example, the requirements for a desired syngas production volume impact the interoperability between systems such as the gasifier 106, the gas treatment unit 110, and the CCP 10. Accordingly, the carbon emission, capture, transport, and usage model 150 may be used, for example, to define a set of design models capable of respecting the requirements that impact systems interoperability.

The model 150 can be utilized to design the CCP 10, by using, for example, suitable modeling techniques (block 246) as described in more detail above with respect to the model 150 and FIGS. 3A-3B. That is, the model 150 may include design models capable of employing techniques such as dynamic simulation modeling. In dynamic simulations modeling, a plurality of simulations of the CCP 10 may be created and each simulation may be used to aid in determining the suitability of various CCP 10 designs to support the application requirements 244. Other design models may include mathematical models, process control models, manufacturing instructions, and so forth. Indeed, a variety of modeling techniques may be used to design a suitable CCP 10 (block 246). The resulting CCP 10 design may include simulation models, CAD drawing, cost estimate models, and so forth, that detail various aspects of the CCP 10. Accordingly, a plurality of CCP 10 specifications, including CO₂ composition and properties 248, may be produced.

The logic 240 is capable of determining if a CCP 10 design meets the application requirements 244, by using, for example, a verification and validation model (decision 250). In one embodiment, verification and validation modeling techniques such as the “ISO 9000 Model for quality assurance in design, development, production, installation, and servicing” may be used, as well as derivatives of the ISO 9000 model (e.g., 9001, 9002, and/or 9003). Other verification and validation techniques that may be used include design reviews, design checklists, and so forth. Each of the application requirements 244 may be verified and/or validated by cross-reference to one or more models included in the CCP 10 design. For example, the requirement for the capture of a given percentage of CO₂ (e.g., 70, 80, or 90 percent capture), may be independently verified and validated by reference to the CO₂ capture simulation model that predicts that the CCP 10 embodiment is capable of extracting at least approximately 70, 80, or 90 percent of the CO₂. If the verification and validation model determines that the CCP 10 design is not capable of meeting the application requirements 244 (decision 250), then the design models for the CCP 10 may be redesigned at block 246. If the verification and validation model determines that the CCP 10 design is capable of meeting the application requirements 244 (decision 250), then the gasification process may be designed (block 252) and downstream requirements may be specified (block 254).

As mentioned above, the gasification process may be designed by using the model 150, including a plurality of models, such as dynamic simulation models, mathematical models, process control models, manufacturing instructions, and so forth (block 252). The gasification design (block 252) results in the creation of a plurality of design data, such as a syngas composition and syngas properties 256. The syngas composition may include specifications on the mole percentage of the syngas components (e.g., H₂, CO, CH₄) that may be produced by the gasification process. Syngas properties may include combustion characteristics, percent yield (e.g., moles of syngas per moles of fuel), kilocalories per mole of syngas, and so forth.

As illustrated, the logic 240 is also capable of capturing the specification of downstream requirements (block 254). The downstream requirements include requirements applicable to systems downstream of the IGCC plant 100 and the CCP 10, for example, the pipeline system 18, the CO₂ sequestration system 20 and the EOR 22. Accordingly, the requirements may include a plurality of the requirements described in FIGS. 4-7 above. The downstream requirements may be captured using a variety of tools such as requirements databases, spreadsheets, text documents, and so forth. The result of the specification of downstream requirements (block 254) is a plurality of downstream requirements such as syngas and CO₂ flow rate and composition requirements (258). The requirements data may also include interoperability information such as cross-references to the systems impacted by each requirements datum, the amount of the interoperability, the type of interoperability, and so forth.

The logic 240 is then capable of using a verification and validation model to validate and verify the design of the gasification process and/or the design of the CCP 10 (decision 260). In one embodiment, the verification and validation model may use techniques such as the ISO 9000 modeling techniques described above, to validate and verify the designs. Other techniques such as design reviews, design checklists, and so forth may also be used. Additionally, regulatory requirements such as NESHAP and/or MACT requirements may be verified and validated. For example, plant startup, shutdown, and/or fault conditions may be simulated and then verified and validated against NESHAP and/or MACT requirements. If the logic 240 determines that the requirements have not been met (decision 260), then the gasification process and/or the CCP 10 may be re-designed and the design and requirements data may be updated, as illustrated. If the logic 240 determines that the requirements have been met (decision 260), then the logic 240 is capable of designing the pipeline and downstream processing using modeling techniques (block 262) as described above in reference to model 150 and FIGS. 3A-3B.

The logic 240 is capable of designing the plant using a plurality of modeling techniques, including dynamic simulation, computational flow dynamics (CFD), mathematical models, process control models, manufacturing model, and so forth. Accordingly, interoperability between systems is incorporated in the design and may be optimized. Indeed, by using the techniques described herein, it may be possible to create an optimal plant design capable of meeting regulatory compliance targets (block 264).

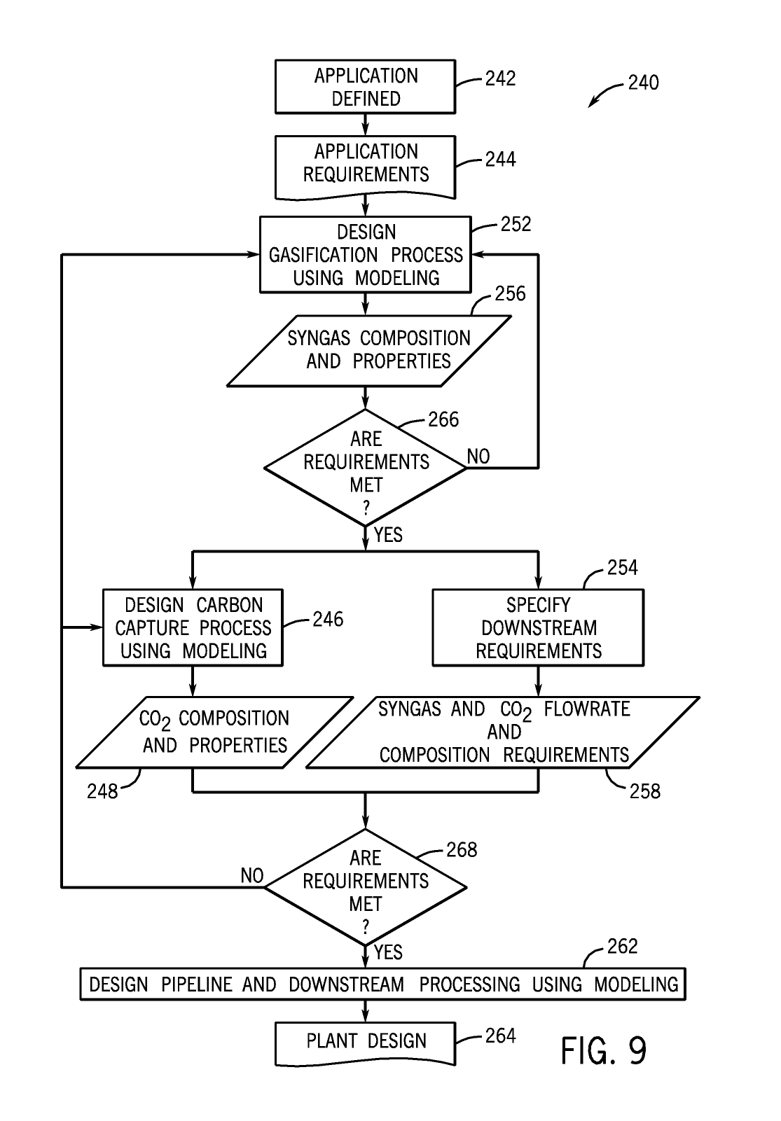

FIG. 9 illustrates another embodiment of the logic 240. In the illustrated embodiment, the gasification process is designed before the CCP 10. Indeed, the techniques disclosed herein are capable of designing the various systems in any desired ordering, including sequential and/or a parallel ordering. In the depicted embodiment, the logic 240 is capable of defining an application (block 242). As mentioned above, the application definition is useful in capturing the scope and breadth of the project, including desired power output capabilities, desired CO₂ capture goals (e.g., percentage of CO₂ captured), desired CO₂ flow rates through the pipeline system 18, desired usage for the transported CO₂, and so forth. The application may be defined, for example, by selecting a project site for the IGCC power plant 100 and CCP 10, defining a forecast power demand (e.g., monthly demand, on-peak demand, off-peak demand), defining expected primary fuel, expected backup fuel, desired CO₂ capture percentage, and so forth. The definition of an application may also include defining usage sources for the storage and/or use of the captured CO₂. For example, a CO₂ sequestration facility 20 such as the saline aquifer may be chosen, and/or an EOR activity such the oil well reclamation (e.g., CO₂ injection) may be chosen. The application definition may also include defining CO₂ transportation facilities, such as new or existing pipeline systems 18, to be used in delivering the captured CO₂.

Consequently, the logic 240 may include a plurality of application requirements 244 that result from the application definition (block 242) of the logic 240. The application requirements 244 may be entered and stored in, for example, a requirements database, a spreadsheet, a text document, and so forth. The application requirements 244 may include, for example, the pipeline requirements 194, saline aquifer requirements 196, EOR requirements 198, carbon capture requirements 210, and other requirements 206, 218, 228 and 238, as described in more detail above with respect to FIGS. 4-7. Accordingly, the logic 240 is capable of storing a plurality of application requirements suitable for designing and/or retrofitting the carbon emitting plant (e.g., IGCC plant 100), the CCP 10, the carbon transportation system (e.g., pipeline system 18), and the carbon usage system (e.g., CO₂ sequestration system 20, EOR 22). Indeed, many of the stored application requirements 244 are requirements that impact interoperability between systems. For example, the requirements for a desired syngas production volume impact the interoperability between systems such as the gasifier 106, the gas treatment unit 110, and the CCP 10. Accordingly, the carbon emission, capture, transport, and usage model 150 may be used, for example, to define a set of design models capable of respecting the requirements that impact systems interoperability.

The model 150 can be utilized to design the gasification process, by using, for example, suitable modeling techniques (block 252) as described in more detail above with respect to the model 150 and FIGS. 3A-3B. That is, the model 150 may include design models capable of employing techniques such as dynamic simulation modeling, among others. Indeed, a variety of modeling techniques may be used to design a suitable gasification process (block 252). A plurality of syngas composition and properties (block 256) may be produced based on the design of the gasification process (block 252).

The logic 240 is capable of determining if the gasification process design meets the application requirements 244, by using, for example, a verification and validation model (decision 266). In one embodiment, verification and validation modeling techniques such as the “ISO 9000 Model for quality assurance in design, development, production, installation, and servicing” may be used, as well as derivatives of the ISO 9000 model (e.g., 9001, 9002, and/or 9003). Other verification and validation techniques that may be used include design reviews, design checklists, and so forth. Each of the application requirements 244 may be verified and/or validated by cross-reference to one or more models included in the gasification design. For example, the requirement for a desired flow volume of syngas may be independently verified and validated by reference to the gasification process simulation model that predicts approximately the desired flow volume. If the verification and validation model determines that the gasification process design is not capable of meeting the application requirements 244 (decision 266), then the design models for the gasification process may be redesigned at block 252. If the verification and validation model determines that the gasification process design is capable of meeting the application requirements 244 (decision 266), then the CCP 10 may be designed (block 246) and downstream requirements may be specified (block 254).

As mentioned above, the CCP 10 may be designed by using the model 150, including a plurality of models, such as dynamic simulation models, mathematical models, process control models, manufacturing instructions, and so forth (block 246). The CCP 10 design (block 246) results in the creation of a plurality of design data, such as a CO₂ composition and properties 248. The CO₂ composition and properties 248 may include specifications on the purity of the CO₂, particulate matter counts, flow rates, volumes, and pressures, among others.

As illustrated, the logic 240 embodiment is also capable of capturing the specification of downstream requirements (block 254). The downstream requirements include requirements applicable to systems downstream of the IGCC plant 100 and the CCP 10, for example, the pipeline system 18, the CO₂ sequestration system 20 and the EOR 22. Accordingly, the requirements may include a plurality of the requirements described in FIGS. 4-7 above. The downstream requirements may be captured using a variety of tools such as requirements databases, spreadsheets, text documents, and so forth. The result of the specification of downstream requirements (block 254) is a plurality of downstream requirements such as syngas and CO₂ flow rate and composition requirements (258). The requirements data may also include interoperability information such as cross-references to the systems impacted by each requirements datum, the amount of the interoperability, the type of interoperability, and so forth.

The logic 240 is then capable of using a verification and validation model to validate and verify the design of the gasification process and/or the design of the CCP 10 (decision 268). In one embodiment, the verification and validation model may use techniques such as the ISO 9000 modeling techniques described above, to validate and verify the designs. Other techniques such as design reviews, design checklists, and so forth may also be used. Additionally, regulatory requirements such as NESHAP and/or MACT requirements may be verified and validated. For example, plant startup, shutdown, and/or fault conditions may be simulated and then verified and validated against NESHAP and/or MACT requirements. If the logic 240 determines that the requirements have not been met (decision 268), then the gasification process and/or the CCP 10 may be re-designed and the design and requirements data may be updated, as illustrated. If the logic determines that the requirements have been met (decision 268), then the logic 240 is capable of designing the pipeline and downstream processing using modeling techniques (block 262) as described above in reference to model 150 and FIGS. 3A-3B.

The logic 240 is capable of designing the plant using a plurality of modeling techniques, including dynamic simulation, computational flow dynamics (CFD), mathematical models, process control models, manufacturing instructions, and so forth. Accordingly, interoperability between systems is incorporated in the design and may be optimized. Indeed, by using the techniques described herein, it may be possible to create an optimal plant design (block 264).

Technical effects of the invention include modeling techniques capable of defining the interoperability between a carbon capture system, a plant, a pipeline system, a carbon sequestration system, and enhanced oil recovery activities. The modeling techniques are capable of employing the interoperability definitions to design and simulate one or more of the aforementioned systems. The design and simulations may then be used to arrive at an efficient, interoperable set of systems that also respect a plurality of requirements, including engineering requirements, regulatory requirements, and economic requirements. Indeed, a safe, efficient, regulatory compliant, and cost effective “Greenfield” plant with approximately zero carbon emissions may be designed and built by using the techniques disclosed herein.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A system for enhancing interoperability of a plant comprising:
a carbon emission, capture, transport, and usage model configured to model interrelationships of inputs, outputs, and requirements between a carbon emitting plant, a carbon capture process, a carbon transportation system, and a carbon usage system, wherein the carbon emitting plant is configured to produce a product having a carbonaceous substance, the carbon capture process is configured to capture at least a portion of the carbonaceous substance from the product as a carbonaceous gas, the carbon transportation system is configured to transport the carbonaceous gas from the carbon capture process to the carbon usage system, and the carbon usage system is configured to receive the carbonaceous gas transported by the carbon transportation system.

2. The system of claim 1, comprising a controller configured to control operation of the carbon emitting plant and the carbon capture process based on the carbon emission, capture, transport, and usage model.

3. The system of claim 1, comprising the carbon emitting plant and the carbon capture process configured to operate based on the carbon emission, capture, transport, and usage model.

4. The system of claim 1, wherein the carbon emission, capture, transport, and usage model comprises a carbon capture model configured to model a carbon capture percentage of the carbonaceous gas and a plurality of properties of the carbonaceous gas.

5. The system of claim 4, wherein the carbon capture model comprises a pre-combustion carbon capture model, a post-combustion carbon capture model, a modified combustion carbon capture model, or a combination thereof.

6. The system of claim 1, wherein the carbon emission, capture, transport, and usage model comprises a carbon emission model configured to model output properties of the product having the carbonaceous substance.

7. The system of claim 6, wherein the carbon emission model comprises a gasification model, a power generation model, a chemical production model, a chemical refinery model, or a combination thereof.

8. The system of claim 1, wherein the carbon emission, capture, transport, and usage model comprises a carbon transport model configured to model transport of the carbonaceous gas by one or more pipelines, each pipeline having a plurality of pipeline specifications.

9. The system of claim 1, wherein the carbon emission, capture, transport, and usage model comprises a carbon usage model, and the carbon usage model comprises an enhanced oil recovery model configured to model a plurality of enhanced oil recovery specifications.

10. The system of claim 1, wherein the carbon emission, capture, transport, and usage model comprises a carbon usage model, and the carbon usage model is configured to receive inputs from and to provide outputs to a carbon sequestration model.

11. The system of claim 1, wherein the carbon emission, capture, transport, and usage model is configured to design, build, retrofit, optimize, permit, or operate an industrial plant, or a combination thereof.

12. A system, comprising:
a gasification section configured to convert a feedstock into a syngas;
a carbon capture section configured to remove a carbonaceous gas from the syngas; and
a controller configured to control operation of the gasification section and the carbon capture section based on a carbon emission, capture, transport and usage model, wherein the carbon emission, capture, transport and usage model is configured to model interrelationships of inputs, outputs, and requirements between the gasification section, the carbon capture section, a pipeline system, and a carbon usage system.

13. The system of claim 12, wherein the carbon emission, capture, transport and usage model comprises a carbon emission model and a carbon capture model, the carbon emission model is configured to model operational parameters of the gasification section and a plurality of syngas properties of the syngas, and the carbon capture model is configured to model a carbon capture percentage of the carbonaceous gas and a plurality of properties of the carbonaceous gas being captured in the carbon capture section.

14. The system of claim 13, wherein the carbon capture model comprises a pre-combustion carbon capture model, a post-combustion carbon capture model, a modified combustion carbon capture model, or a combination thereof, and wherein the carbon emission model comprises a gasification model, a power generation model, a chemical production model, a chemical refinery model, or a combination thereof.

15. The system of claim 13, wherein the carbon emission, capture, transport, and usage model comprises a carbon usage model configured to provide inputs to and to receive outputs from a downstream model, wherein the downstream model comprises a carbon sequestration model, an enhanced oil recovery model, or a combination thereof.

16. The system of claim 15, comprising an enhanced oil recovery model configured to model a plurality of enhanced oil recovery specifications.

17. A method, comprising:
modeling interrelationships of inputs, outputs, and requirements between a gasification system, a carbon capture process, a pipeline system, and a carbon usage system, wherein the gasification system is configured to produce a syngas having a carbonaceous substance, the carbon capture process is configured to capture at least a portion of the carbonaceous substance from the syngas as carbon dioxide (CO₂), the pipeline system is configured to transport the CO₂ from the carbon capture process to the carbon usage system, and the carbon usage system is configured to receive the CO₂ from the pipeline system.

18. The method of claim 17, comprising creating a plant design based on the modeling of the interrelationships between the gasification system, the carbon capture process, the pipeline system, and the carbon usage system.

19. The method of claim 17, comprising creating a plant process control based on the interrelationships between the gasification system, the carbon capture process, the pipeline system, and the carbon usage system.

20. The method of claim 19, comprising optimizing the plant process control by configuring the plant process control to capture at least approximately 50% of the CO₂ in the syngas.
